(19) United States
(12) Patent Application Publication
(10) Pub. No.: US 2015/0304411 A1
(43) Pub. Date: Oct. 22, 2015

(54) Self-Organizing Distributed Service Overlay for Wireless Ad Hoc Networks

(71) Applicant: TELCORDIA TECHNOLOGIES, INC., Plano, TX (US)

(72) Inventors: Kong Eng Cheng, Mendham, NJ (US); Yitzchak M. Gottlieb, Edison, NJ (US); Gary Marc Levin, Bedminster, NJ (US)

(73) Assignee: TELCORDIA TECHNOLOGIES, INC., Plano, TX (US)

(21) Appl. No.: 13/623,434

(22) Filed: Sep. 20, 2012

(51) Int. Cl. H04L 29/08; H04L 29/06

(52) U.S. Cl. CPC H04L 67/1061; H04L 67/42; H04L 67/28

(57) ABSTRACT

An apparatus and a method are operable to enable peer-to-peer communication between a first communication node having a first server application and an associated first client application and a second communication node having a second server application and an associated second client application in a wireless ad hoc network. In one embodiment, the apparatus includes memory including computer program code configured to, with a processor, cause the apparatus to determine an identity and service capability of the second communication node, initiate the first client application on the first communication node, enable the first server application with the first client application on the first communication node to communicate with the second client application via the second server application on the second communication node, and provide a service associated with the first client application and the second client application between the first server application and the second server application.

### GOVERNMENT LICENSE RIGHTS

This invention was developed in part from funding provided under W56HZV-05-C-0724 awarded by the U.S. Army. The government has certain rights in this invention.

### TECHNICAL FIELD

The present invention is directed, in general, to peer-to-peer communication services over wireless ad hoc networks and, more specifically, to self-organizing distributed service overlay, and an apparatus and a method of enabling peer-to-peer communication in a wireless ad hoc network.

### BACKGROUND

A wireless ad hoc network (“WANET,” also referred to as an “ad hoc network”) is a decentralized peer-to-peer (“P2P”) wireless network providing link layer (layer 2) and Internet protocol (“IP”) network layer (layer 3) connectivity across a group of stationary or mobile wireless communication nodes without pre-existing network infrastructure. As technologies for the wireless ad hoc network mature, the network is becoming more accepted for stand-alone deployment, as well as for extended reach and bridging gaps in wireless and mobile environments to provide a close proximity network on-demand. The ad hoc networks may be employed, without limitation, in tactical networks, vehicular networks, home networking, first responder and emergency services, ad hoc group communications, personal and body networking, and machine-to-machine (“M2M”) communications.

A common approach for the wireless ad hoc network to rapidly provide client applications and high level services such as instant messaging and voice over Internet protocol (“VoIP”) is to adopt a centralized client-server service architecture as an application overlay network. The client-server architecture employs server applications hosted on a centralized communication node to offer services such as email services and voice services. The client applications of such architectures communicate with the service applications that provide services to clients resident on other communication nodes. The benefit of an overlay approach is to avoid additional cost and delay of re-creating new peer-to-peer applications by leveraging the existing service architecture and reusing the server and client applications with little modification. The peer-to-peer benefits of the wireless ad hoc network, however, are lost since the network is subject to a single point of control and failure inherent in the centralized service architecture. The client-server architecture is not designed for distributed deployment and peer-to-peer communication over ad hoc networks. The situation is further exacerbated by ongoing partitioning and merging of ad hoc networks that trigger churn in network communication node membership, making network topologies unstable.

The centralized service architecture and its variant of server application replication work well with a relatively stable network topology. The previous approach, however, fails to address the dynamic nature of a wireless ad hoc network wherein the network environment is constantly evolving due to the chum in the network. The client applications require continuous connectivity to the server applications in the core network for ongoing service availability. This may not be the case in the wireless ad hoc network, especially when it involves mobile ad hoc communication nodes.

The replication of server applications is limited in that only a selected subset of communication nodes are equipped with server application capabilities, and are typically centralized in the core network. As such, the network still suffers from the same deficiencies of a single point of failure as the centralized architecture. Replication becomes unreliable for wireless ad hoc network deployment since the topology is highly dynamic. Without the support of stable backbone network connectivity, the replication will not always be successful. The communications overhead for providing reliable replication may be significant due to dynamically changing network topology. Even if replication is successful, the replicated server application cannot be reliably designated as an alternate server application to guarantee the availability thereof. If a server application in a group is out of communication, all communication nodes in the same group will also lose their services.

The wireless ad hoc networks that are overlaid with a centralized service architecture may not support network partitioning or merging. In the former, communication nodes in a new partition that have no access to the communication node running the server application will lose their service. In a merged network, communication nodes that do not belong to the same original network have no mechanism to discover each other. The communication nodes are also not configured to access the new communication node and its server applications even though they may have network connectivity thereto.

Centralized discovery inherits the same deficiencies as the client-server architecture-single point of control and failure. As such, a common previous approach to overcome the limitation of a centralized architecture in fixed and fixed wireless networks is to use peer-to-peer protocols such as CHORD and resource location and discovery (“RELOAD”) to provide decentralized discovery. A main constraint of peer-to-peer protocols is the requirement to operate over a stable network with minimal or no churn to the communication node membership. For instance, the CHORD protocol is designed to work in structured topologies in networks that are relatively stable. While CHORD has been improved for semi-structured topologies in the fixed wireless network where communication nodes may leave and join the network. It is unsuitable for use in an ad hoc network where the topology is highly unstable and unstructured since there is no fixed infrastructure. The peer-to-peer protocols are also complicated and ensuring their correct functioning may not be trivial. The correctness of CHORD is questioned as broken rings in the approach may not repair itself.

In centralized discovery such as employed in the Jini™ architecture, a client application, after locating a service, stills need to bind to the server application of a provider to access the service. In this case, the provider typically adopts the centralized server architecture. More critically, distributed discovery in previous approaches is limited to bounded application environments where all the peer communication nodes in the network are known in a priori and are pre-configured into each communication node; it has no self-organizing capability. In particular, a bounded solution typically requires all client names, server names and server locations to be known in advanced (i.e., statically). Typically, only client locations are discovered dynamically during service runtime.

Limitations of overlay approaches have now become substantial hindrances for development of wireless ad hoc networks to be operable as decentralized peer-to-peer wireless networks. Nonetheless, there has been continued effort to develop link layer and IP network layer connectivity across a group of stationary or mobile communication nodes without relying on a pre-existing network infrastructure and avoiding the hindrances of re-creating new peer-to-peer applications. However, no satisfactory strategy has emerged to provide these capabilities that can address the dynamic nature of a wireless ad hoc network while avoiding the need for a system architecture with a single point of control and failure. Accordingly, what is needed in the art is an architectural approach that overcomes the deficiencies in the current solutions.

### SUMMARY OF THE INVENTION

These and other problems are generally solved or circumvented, and technical advantages are generally achieved, by advantageous embodiments of the present invention, including a self-organizing distributed service overlay, and an apparatus and a method of enabling peer-to-peer communication in a wireless ad hoc network. The apparatus and method are operable to enable peer-to-peer communication between a first communication node having a first server application and an associated first client application and a second communication node having a second server application and an associated second client application in the wireless ad hoc network. In one embodiment, the apparatus includes memory including computer program code configured to, with a processor, cause the apparatus to determine an identity and service capability of the second communication node, initiate the first client application on the first communication node, enable the first server application with the first client application on the first communication node to communicate with the second client application via the second server application on the second communication node, and provide a service associated with the first client application and the second client application between the first server application and the second server application.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIG. 1 illustrates a system level diagram of an embodiment of a communication system operable in a wireless ad hoc network;

FIG. 2 illustrates a block diagram of an embodiment of a decentralized service architecture employing co-location of server and client applications;

FIG. 3 illustrates a block diagram of an embodiment of a self-organizing distributed service overlay for a plurality of communication nodes in a wireless ad hoc network;

FIG. 4 illustrates a block diagram of an embodiment of a self-organizing distributed service overlay for communication node in a wireless ad hoc network;

FIGS. 5 to 9 illustrate block diagrams of embodiments of first and second communication nodes communicating in a wireless ad hoc network;

FIG. 10 illustrates a block diagram of an embodiment of a self-organizing distributed service overlay demonstrating a naming and an address assignment service;

FIG. 11 illustrates a block diagram of an embodiment of a self-organizing distributed service overlay demonstrating session initiation protocol related services; and

FIG. 12 illustrates a flow diagram of an embodiment of a method of enabling peer-to-peer communication between a plurality of communication nodes in a wireless ad hoc network.

Corresponding numerals and symbols in the different figures generally refer to corresponding parts unless otherwise indicated, and may not be redescribed in the interest of brevity after the first instance. The FIGUREs are drawn to illustrate the relevant aspects of exemplary embodiments.

### DETAILED DESCRIPTION OF ILLUSTRATIVE EMBODIMENTS

The making and using of the present exemplary embodiments are discussed in detail below. It should be appreciated, however, that the embodiments provide many applicable inventive concepts that can be embodied in a wide variety of specific contexts. The specific embodiments discussed are merely illustrative of specific ways to make and use the systems, subsystems and modules associated with a system with a self-organizing distributed service overlay (“SODSO”).

The system with the self-organizing distributed service overlay for a wireless ad hoc network will be described with respect to exemplary embodiments in a specific context, namely, a self-organizing distributed service overlay for a wireless ad hoc network that enables a communication node such as a cellular telephone, notebook computer, tablet, etc. to communicate peer-to-peer with another communication node without the need for an intervening network node such as a cellular base station. While the principles will be described in the environment of an ad hoc network, any environment that may benefit from a wireless communication system that enables peer-to-peer communication between communication nodes is well within the broad scope of the present disclosure.

Most commercial applications and communication services are deployed over a vast geographical area use a wide area network (“WAN”). The services are typically centralized in and operate over a wireline and/or a fixed wireless environment. While wireless ad hoc networks usually focus on covering a local area with small geographic size known as close proximity networks, such networks are not limited thereby. The geographical areas covered by wireless ad hoc networks continue to increase with advances in new radio transceivers and transmission technologies. The wireless ad hoc networks can also be used as bridging networks between two disjointed networks.

As introduced herein, a methodology and design are provided for a self-organizing distributed service overlay for a wireless ad hoc network. A self-organizing distributed service overlay allows reuse of applications and services in the previously centralized architecture over a wireless ad hoc network without the disadvantage of a single point of control and failure that is inherent in a centralized approach. A self-organizing distributed service overlay also provides self-organization for automatic overlay formation of distributed services through mirroring and integration with the underlying ad hoc network routing data. Cross-layer binding in the self-organizing distributed service overlay simplifies the overlay by eliminating redundant naming services and peer-to-peer discovery protocols.

In a centralized service architecture, a server application acts as the central point of control for providing and managing services offered to remote client applications on remote communication nodes. (See, e.g., 3GPP Technical Specification (“TS”) 23.228, entitled “Technical Specification Group Services and System Aspects: IP Multimedia Subsystem (IMS),” Stage 2, Release 11, March 2012, and “Client/Server Architecture,” by Alex Berson, McGraw-Hill Computer Communications Series, Mar. 29, 1996, which are incorporated herein by reference.) A variant to the centralized architecture to avoid a single point of failure is to replicate server applications and the associated data to provide backup. While this can be effective for the reliability of wireline networks and fixed wireless environments, the fundamental architecture remains unchanged because replication is still centralized in the core network that hosts the server applications and data. The client applications require continuous connectivity to the core network where the server applications reside for ongoing service availability.

Services in peer-to-peer networks have no centralized management and are located through a discovery process. The existing service discovery architecture typically uses a centralized registration mechanism that requires server applications (by providers) in a communication node to register their services in a central registry, and for client applications (on communication nodes such as user equipment) to subscribe to the registry. (See, e.g., “Jini in a Nutshell,” by Oaks, et al., O'Reilly, March 2000 and “Jini™ Architecture Specification,” Sun Microsystems, Inc., 2001, which are incorporated herein by reference). Centralized registration is unsuitable for wireless ad hoc network deployment as it inherits similar deficiencies as the centralized server architecture.

An unbounded wireless ad hoc network environment is supported by processes introduced herein wherein client application names and locations, and server application names and locations associated with each application are discovered in real time (i.e., dynamically). In this case, mirroring a distributed service overlay with self-discovery and routing at the ad hoc network layer provides a bounded number of peer communication nodes at the service overlay layer. As such, cross-layer binding reduces the previously unbounded approach to one that is bounded, wherein communication node memberships are automatically discovered and organized based on the underlying ad hoc routing table of each communication node instead of being pre-configured as in the previous bounded approach. Cross-layer binding as introduced herein with underlying ad hoc routing capabilities results in automatic formation of a distributed service overlay topology that organizes itself according to changes in the peer-to-peer network topology. Existing approaches require prior knowledge and pre-registration of client and server application names (i.e., pre-organization is needed in the service network).

The combination of co-location and an ad hoc-routing-driven application overlay create a meshed peer-to-peer application network without the need to introduce a peer-to-peer protocol overlay. This situation does not arise in wireline and fixed wireless environments where routing is not designed for discovery and requires a peer-to-peer protocol overlay. Networks in these environments are highly stable and communication nodes are located through a centralized service architecture, which is not the case for wireless ad hoc network, as ad hoc communication nodes are standalone and are not attached to any pre-existing backbone or core networks. In addition, naming services such as domain name services (“DNS”) provide mapping of names (of client and server applications) to their locations (e.g., their IP address). The need for a naming service and a peer-to-peer protocol overlay are eliminated, both of which are mandatory functions needed for discovery and peering in fixed networks.

Native peer-to-peer communications (at the network layer and application specific protocols) are provided for all the client and server applications as well as distributed service discovery in the network. The previous approaches are hybrid solutions that provide a combination of peer-to-peer discovery infrastructure and centralized service. For instance, a session initiation protocol (“SIP”) allows peer-to-peer discovery of client application location through a peer-to-peer protocol known as RELOAD. (For information about SIP, see, e.g., “SIP: Session Initiation Protocol,” by J. Rosenberg, et al., IETF RFC 3261, June 2002, which is incorporated herein by reference). However, service applications and service discovery in a peer-to-peer session initiation protocol may still be centralized.

The communication nodes in fixed networks typically do not move or relocate around the network, which eliminates the need for network merging and partitioning. Even if the communication nodes do move or relocate, a centralized server or registry manages all communication node locations. Occasional movement of communication nodes, typically running client applications, generally have little impact on the core network topology. In an ad hoc network, since there is no fixed backbone, any movement of a communication node impacts the entire network. Merging and partitioning capabilities are introduced to manage a constantly evolving topology. A server replication approach is limited in that only a selected subset of communication nodes are equipped with server capabilities, and are typically centralized in the core network. As such, it still suffers from the same deficiencies of a single point of failure as the centralized architecture.

The self-organizing distributed service overlay architecture illustrated and described hereinbelow introduces the notion of pairing a client application with its own server application through co-locating the pair on a communication node. No such degree of redundancy is available in conventional solutions. Co-location and distributed discovery make the service communication node autonomous and self-sufficient. This also ensures that a client application is always connected to a server application, eliminating one of the two causes of application network failure due to loss connectivity. The result is a distributed service architecture that provides an unbounded structure for the wireless ad hoc network that is self-organizing and distributed.

In conventional solutions, the approach to providing peer-to-peer capabilities for an application network is through a peer-to-peer discovery protocol, typically over a wireline or a fixed wireless network. Conventional peer-to-peer protocols such as CHORD are designed for structured topologies that require a stable network, and these are not suitable to operate over wireless ad hoc networks with highly unstructured topologies. In order to find the location of a communication node, RELOAD is conventionally used as a peer-to-peer mechanism by the session initiation protocol to replace the centralized location service. However, the services still reside on a centralized session initiation protocol server. More importantly, the conventional solutions are limited to bounded environments where client and server application names and locations (through a domain name system) are known in advance. The wireless ad hoc network solution introduced herein supports an unbounded environment wherein client and server application names are discovered real time and without prior knowledge.

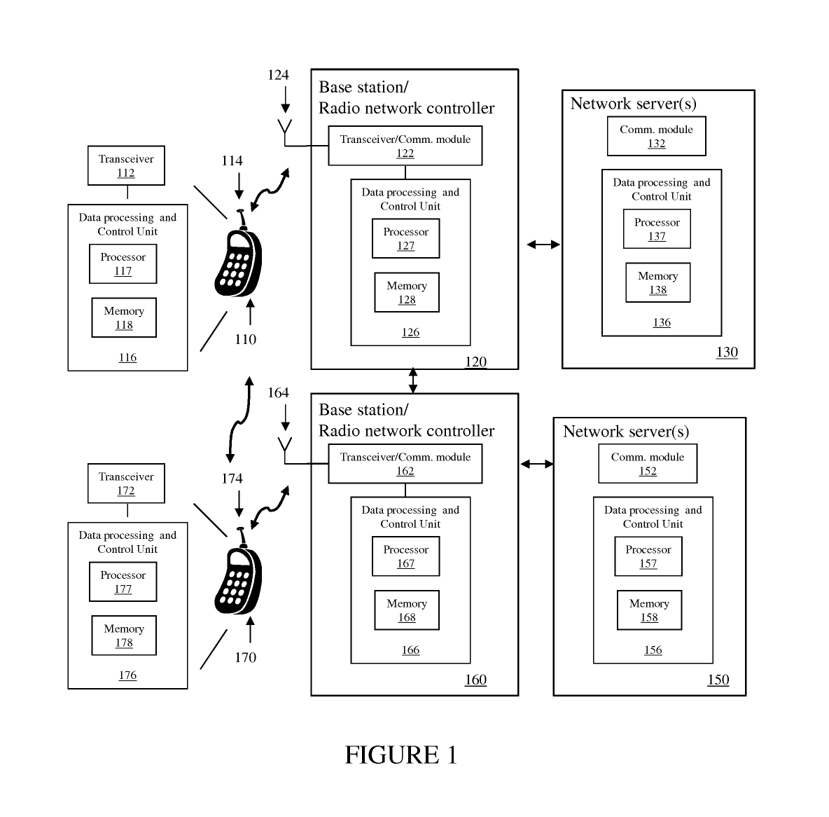

Turning now to FIG. 1, illustrated is a system level diagram of an embodiment of a communication system operable in a wireless ad hoc network. The communication system may form a portion of a cellular terrestrial radio access network and includes a user equipment 110 communicating wirelessly and bidirectionally with a base station and radio network controller 120. While illustrated as a single entity, it should be noted that the base station and radio network controller 120 are typically separate entities in the communication system. The base station and radio network controller 120 is coupled to another base station and radio network controller 160 which is coupled wirelessly and bidirectionally to another user equipment 170. While illustrated as a single entity, it should be noted that the another base station and radio network controller 160 are typically separate entities in the communication system. The another base station and radio network controller 160 is coupled, in turn, to a server(s) 150 including, for instance, an application server.

The base station and radio network controller 120 may be provided by a service provider and the another base station and radio network controller 160 may be provided by another service provider. The communication system may also form part of a wireless ad hoc network wherein the user equipment 110 and the another user equipment 170 communication bi-directionally without, at least in part, employing the resources of the base station and radio network controller 120 and the another base station and radio network controller 160. The user equipment 110 and the another user equipment 170 are equipped with a self-organizing distributed service overlay that also enables communication wirelessly and bidirectionally therebetween in the wireless ad hoc network.

The user equipment 110 and the another user equipment 170 are formed with a transceiver 112, 172, respectively, coupled to an antenna 114, 174, respectively. Of course, multiple antennas may be employed to advantage. The user equipment 110 and the another user equipment 170 include a data processing and control unit 116, 176, respectively, formed with a processor 117, 177, respectively, coupled to a memory 118, 178, respectively. Of course, the user equipment 110 and the another user equipment 170 include other elements such as a keypad, a display, interface devices, etc. The user equipment 110 and the another user equipment 170 are generally a self-contained wireless communication device intended to be carried by an end user (e.g., subscriber stations, terminals, mobile stations, machines, notebook computers, tablets, or the like).

The base station and radio network controller 120 and the another base station and radio network controller 160 are formed with a transceiver/communication module 122, 162, respectively, coupled to an antenna 124, 164, respectively. Of course, multiple antennas may be employed to advantage. Also, the transceiver/communication module 122, 162 are configured for wireless and wired communication. The base station and radio network controller 120 and the another base station and radio network controller 160 may provide point-to-point and/or point-to-multipoint communication services. The base station and radio network controller 120 and the another base station and radio network controller 160 include a data processing and control unit 126, 166, respectively, formed with a processor 127, 167, respectively, coupled to a memory 128, 168, respectively. Of course, the base station and radio network controller 120 and the another base station and radio network controller 160 include other elements such as a interface devices, etc.

The base station and radio network controller 120 and the another base station and radio network controller 160 may host functions such as radio resource management. For instance, the base station and radio network controller 120 and the another base station and radio network controller 160 may perform functions such as internet protocol (“IP”) header compression and encryption of user data streams, ciphering of user data streams, radio bearer control, radio admission control, connection mobility control, dynamic allocation of communication resources to user equipment 110 and the another user equipment 170 in both the uplink and the downlink, and measurement and reporting configuration for mobility and scheduling. The base station and radio network controller 120 and the another base station and radio network controller 160 generally provide access to a telecommunication network such as a public service telecommunications network (“PSTN”). Access may be provided using fiber optic, coaxial, twisted pair, microwave communications, or similar link coupled to an appropriate link-terminating element.

The server(s) 130, 150 are formed with communication modules 132, 152, respectively. The server(s) 130, 160 also include data processing and control units 136, 156, respectively, formed with processors 137, 157, respectively, coupled to corresponding memories 138, 158. Of course, the server(s) 130, 150 include other elements such as interface devices, etc.

The data processing and control units identified above provide digital processing functions for controlling various operations required by the respective unit in which it operates, such as radio and data processing operations to conduct bidirectional wireless communications between radio network controllers and a respective user equipment coupled to the respective base station. The processors in the data processing and control units are each coupled to memory that stores programs and data of a temporary or more permanent nature.

The processors in the data processing and control units, which may be implemented with one or a plurality of processing devices, performs functions associated with its operation including, without limitation, precoding of antenna gain/phase parameters, encoding and decoding of individual bits forming a communication message, formatting of information and overall control of a respective communication element. Exemplary functions related to management of communication resources include, without limitation, hardware installation, traffic management, performance data analysis, configuration management, security, billing and the like. The processors in the data processing and control units may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The memories in the data processing and control units may be one or more memories and of any type suitable to the local application environment, and may be implemented using any suitable volatile or nonvolatile data storage technology such as a semiconductor-based memory device, a magnetic memory device and system, an optical memory device and system, fixed memory and removable memory. The programs stored in the memories may include program instructions or computer program code that, when executed by an associated processor, enable the respective communication element to perform its intended tasks. Of course, the memories may form a data buffer for data transmitted to and from the same. In the case of the user equipment, the memories may store applications (e.g., virus scan, browser and games) for use by the same. Exemplary embodiments of the system, subsystems, and modules as described herein may be implemented, at least in part, by computer software executable by processors of the data processing and control units, or by hardware, or by combinations thereof.

The transceivers modulate information onto a carrier waveform for transmission by the respective communication element via the respective antenna(s) to another communication element. The respective transceiver demodulates information received via the antenna(s) for further processing by other communication elements. The transceiver is capable of supporting duplex operation for the respective communication element. The communication modules further facilitate the bidirectional transfer of information between communication elements.

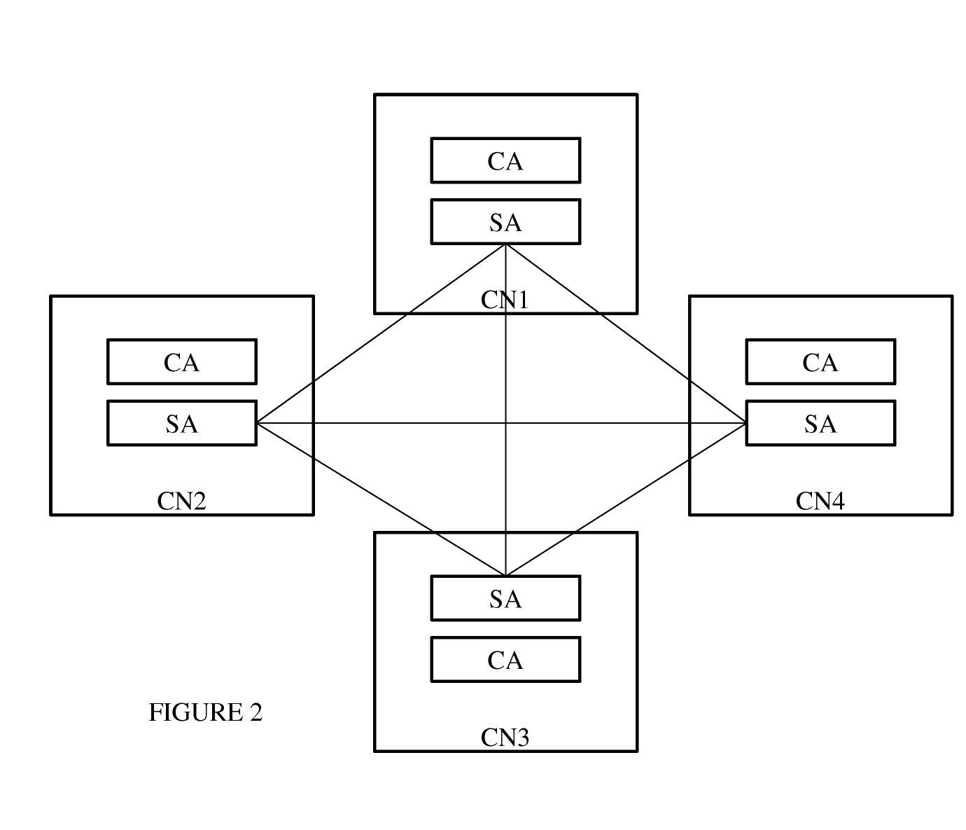

Turning now to FIG. 2, illustrated is a block diagram of an embodiment of a decentralized service architecture employing co-location of server and client applications. Co-location and autonomous overlay by a self-organizing distributed service overlay produces a new peer-to-peer service network over wireless ad hoc network that has distributed control. The result is a self-organizing distributed service overlay without a single point of control and failure. The service architecture is employable with communication nodes CN1, CN2, CN3, CN4 (e.g., user equipment), each formed with at least one respective co-located client application (“CA”) and server application (“SA”). The communication nodes CN1, CN2, CN3, CN4 are connected in a mesh architecture wherein each communication node (e.g., communication node CN1) can communicate peer-to-peer with another communication node (e.g., communication node CN2).

A client application CA is thus paired with its own server application SA through co-locating the pair on the same communication node (e.g., communication node CN1). No such degree of redundancy is available in previous solutions. Co-location and distributed discovery makes the communication nodes CN1, CN2, CN3, CN4 autonomous and self-sufficient. It also ensures that a client application CA is connected to a server application SA, eliminating one of the two causes of application network failure due to loss connectivity. The result is a robust distributed service architecture that is immune to failure of a centralized server.

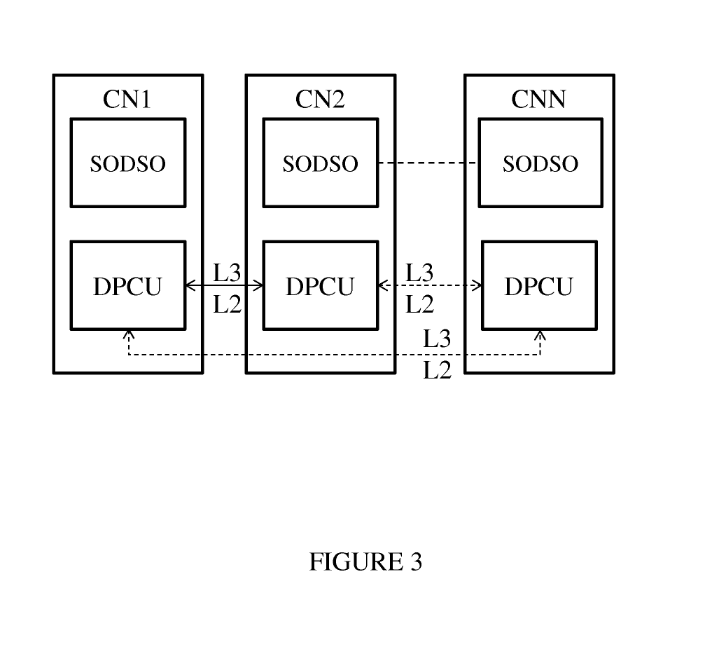

Referring now to FIG. 3, illustrated is a block diagram of an embodiment of a self-organizing distributed service overlay for a plurality of communication nodes in a wireless ad hoc network. The limitations of an overlay approach for creating wireless ad hoc networks in a peer-to-peer environment can be resolved by creating a self-organizing distributed service overlay network for deploying and distributing server applications and communications services to individual communication nodes in a wireless ad hoc network. An objective is to eliminate a single point of control and failure in the current client/server service architecture when deployed over a wireless ad hoc network, and to retain the benefits of reusing the architecture, its associated protocols, and client and server applications.

As illustrated in FIG. 3, a plurality of communication nodes CN1, CN2, CNN (e.g., user equipment) include data processing and control units (designated “DPCU”) operating a self-organizing distributed service overlay (designated “SODSO”). The first communication node CN1 is coupled to the second communication node CN2 over an IP network layer (layer 3, “L3”) and a link layer (layer 2, “L2”) to provide IP or e-mail service for an IP client application therebetween, and to provide voice communication services for another client application between the first and second communication nodes CN1, CN2. Similarly, the first and second communication nodes CN1, CN2 are coupled to other communication nodes CNN in an analogous manner.

A wireless ad hoc network is thus formed with a plurality of interconnected communication nodes free of fixed network infrastructure and free of a centralized application that provides the necessary communication or operational connectivity. For a better understanding of wireless ad hoc networks, see “A Quick Guide to AODV Routing,” by Luke Klein-Berndt, Wireless Communications Technologies Group, National Institute of Standards and Technology, and entitled “Guide to Wireless Ad Hoc Networks,” by Misra, et al., Springer-Verlag London Limited, 2009, which are incorporated herein by reference. The wireless ad hoc network supports auto-configuration and establishment of connectivity at the IP network layer (layer 3) and at the link layer (layer 2) across peer communication nodes. A service overlay that could be installed in a centralized server is now installed in a distributed arrangement as a self-organizing distributed service overlay in each communication node to eliminate a centralized communication architecture.

Thus, if a centralized server is incapacitated or is otherwise inaccessible, the communication nodes (with its own server application) in a wireless ad hoc network can continue to communicate or even initiate a new communication through a peer communication node (with its own server application) employing the distributed architecture and automatic ad hoc network reconfiguration. The server application in one communication node communicates as needed with the server application in another communication node. In this arrangement, local applications do not necessarily have to be altered, and no or little hardware needs to be added to the communication nodes.

Each communication node can retain communication capability with a fixed telecommunications network backbone (e.g., a wireline network) through the ad hoc network. Moreover, each communication node can now communicate with another communication node in its local physical area even when an access point to a public network is not accessible. Each communication node can be formed with a conventional protocol to discover nearby communication nodes. The number of nearby communication nodes that can participate in an ad hoc network can be variable over time (i.e., the ad hoc network topology can evolve over time). A communication node that assumes a level of continuous connectivity with the centralized server can continue to use clients/applications designed to work with a centralized server. A wireless ad hoc network like other peer-to-peer networks has no pre-determined location and infrastructure to find services or to locate whereabouts of client and server applications.

The client applications and advanced services are initially established and managed on individual communication nodes in the wireless ad hoc network. The services overlay enhances a communication node with a client-server co-location (“CSCO”) function to provide autonomous client applications and distributed server client-server co-location applications through co-hosting on the same communication node. Co-location of client and server applications increases availability of applications (that were previously centralized) when deployed in a peer-to-peer environment. The enhanced communication nodes enable instant formation of ad hoc communication services free of a pre-determined application network. An objective is to design an ad hoc network free of a centralized server to avoid a single point of control and failure in existing client-server or network-based architectures.

A further problem for a wireless ad hoc network involves developing methods for self-organization, including discovery and management of application peers through an autonomous service overlay (“ASO”) function. An autonomous service overlay function manages name and identity and location and address information of client and server applications, services and capabilities of communication nodes in the wireless ad hoc network to ensure continuity in peer communications, and service access as network topology changes due to communication nodes leaving or joining the network.

As introduced herein, a communication node, such as, without limitation, a smart cellular telephone or a notebook computer, is formed with a self-organizing distributed service overlay to initiate and continue communication with another communication node, also formed with a self-organizing distributed service overlay, to enable peer-to-peer communication without the need for one or more intervening communication nodes in the communication path, and without the need for a specialized or a modified peer-to-peer application. An intervening communication node that creates a localized, but centralized communication node remote from the client application might even be a personal computer. Thus, two communication nodes with a self-organizing distributed service overlay will be able to communicate peer-to-peer without the need for one or more intervening centralized nodes/access points such as base stations, even if they normally subscribe to different network service providers. A self-organizing distributed service overlay includes a local server application in each communication node to initiate and enable peer-to-peer communication. Communication services include, for example, a smart cellular telephone communicating with a local wirelessly enabled machine such as a residential thermostat, an automobile, a heart monitor, etc.

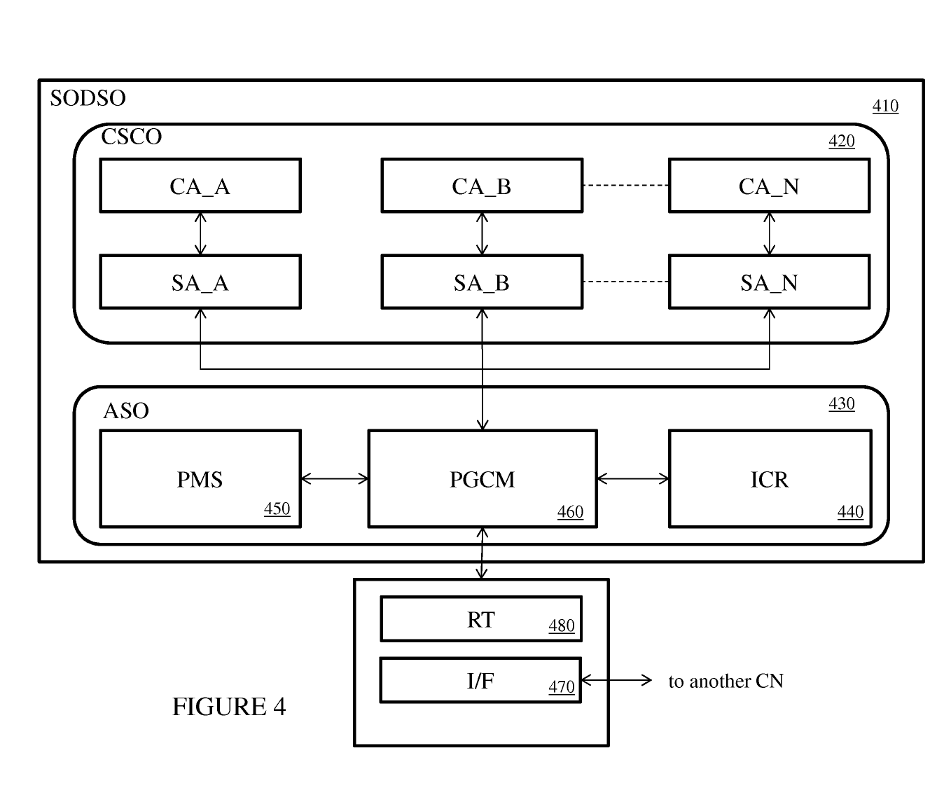

Turning now to FIG. 4, illustrated is a block diagram of an embodiment of a self-organizing distributed service overlay 410 for communication node in a wireless ad hoc network. The self-organizing distributed service overlay 410 is formed with a client-server co-location module 420 and an autonomous service overlay module 430. The client-server co-location module 420 is formed with one or more server applications SA_A, SA_B, SA_N and client applications CA_A, CA_B, CA_N (e.g., voice, web browser, short message service (“SMS”) or e-mail applications). A local server application such as a voice over Internet protocol (“VoIP”) server application or a messaging/e-mail server application hosts and manages one or more applications for supported services (e.g., a VoIP call or an e-mail), and is dedicated to serving client applications on, for instance, the same communication node. A client application provides access to services located on the server applications.

The autonomous service overlay module 430 is formed with an identity and capability registrar (“ICR”) 440 that maintains service and network capabilities of the communication node and manages user name or identity associated with each service such as a session initiation protocol (“SIP”). It provides binding of multiple client application names/identities to a communication node's IP address. The information maintained in the identity and capability registrar 440 includes an IP address of the local communication node, a list of services and associated server application names on the local communication nodes, and a list of client application names or identities associated with the services, on the local communication nodes. An example of information maintained in identity and capability registrar 440 is what local communication node(s) can be employed as a relay communication node to communicate peer-to-peer with another local communication node.

The autonomous service overlay module 430 further includes a peer management service (“PMS”) module 450. The peer management service module 450 maintains names or identities of peer communication nodes and their service capabilities (such as e-mail, short messaging service (“SMS”), VoIP, etc.). The information maintained in the peer management service module 450 for each of the peer communication nodes includes an IP address of connected peer communication nodes, a list of services and associated server application names on all connected peer communication nodes, and a list of client application names or identities associated with the services on all connected peer communication nodes. The peer management service module 450 thus provides at least a portion of services ordinarily obtained from a domain name system (“DNS”).

The autonomous service overlay module 430 further includes a proxy and group communication manager (“PGCM”) 460. The proxy and group communication manager 460 communicates with another communication node via an interface 470 in conjunction with a routing table 480. The proxy and group communication manager 460 monitors updates in the routing table 480, manages communication with external self-organizing distributed service overlay of the another communication node, and coordinates internal and external communication of the self-organizing distributed service overlay 410 and proxy on behalf of the communication node. The routing table 480 is able to provide an initial list of nearby communication nodes that are capable of engagement in a wireless ad hoc network. Other communication nodes that are capable of engagement in the wireless ad hoc network can be found by wireless discovery.

The routing table driven approach uses discovery at the network layer to provide a mirrored overlay topology and a bounded number of peer communication nodes employed by the service overlay network. As such, through cross-layer integration, the unbounded solution is reduced to one that is bounded where communication node memberships are automatically discovered from the underlying ad hoc network routing table of each communication node instead of being pre-configured from an initial bounded solution.

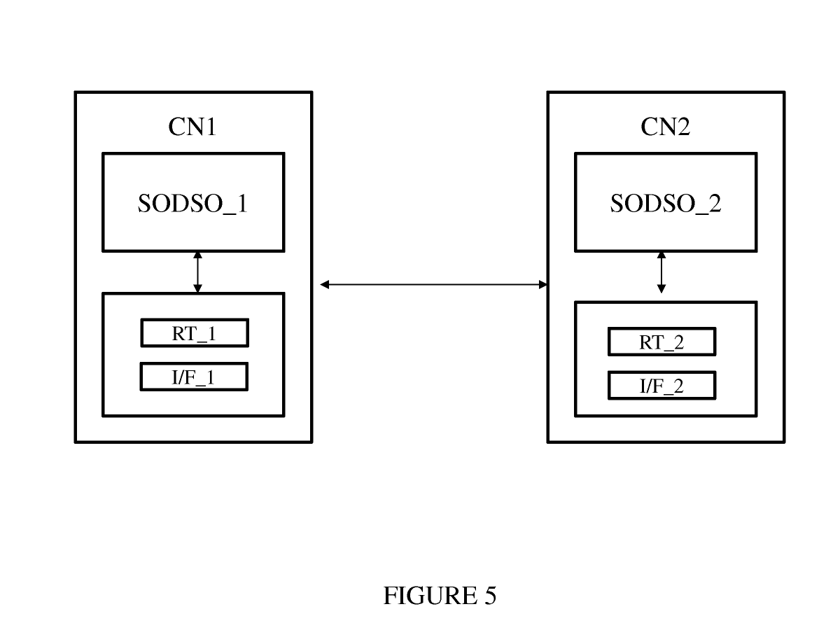

Turning now to FIGS. 5 to 9, illustrated are block diagrams of embodiments of first and second communication nodes CN1, CN2 communicating in a wireless ad hoc network. Beginning with FIG. 5, the first and second communication nodes CN1, CN2 include first and second self-organizing distributed service overlays SODSO_1, SODSO_2, respectively. The first and second communication nodes CN1, CN2 communicate through first and second interfaces I/F_1, I/F_2, respectively, in conjunction with first and second routing tables, RT_1, RT_2, respectively. The first and second communication nodes CN1, CN2 demonstrate self-organizing distributed service overlay cross-layer interactions to provide a process for discovery of peer communication nodes and their capabilities over the wireless ad hoc network.

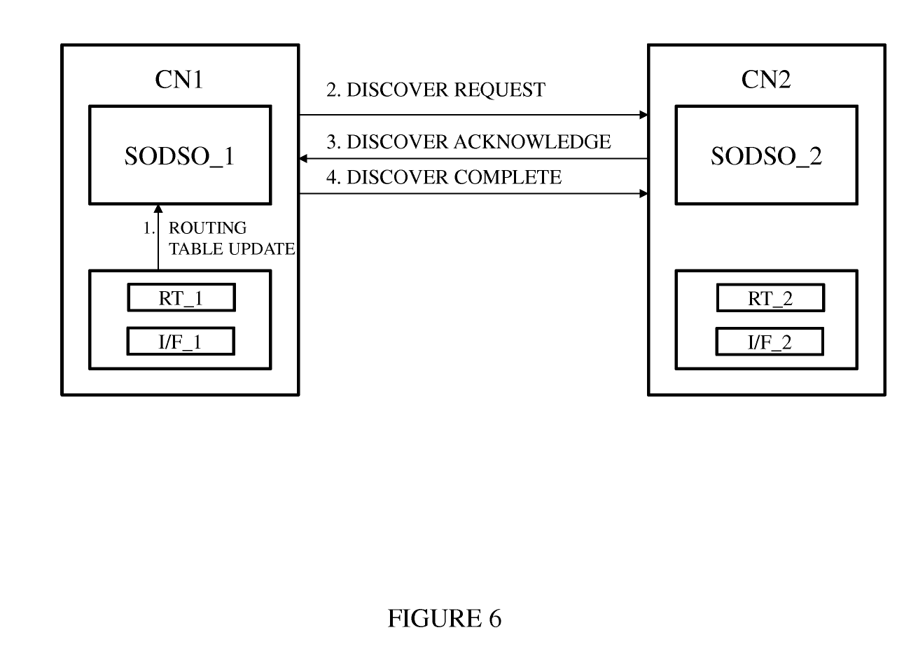

Turning now to FIG. 6, the first and second communication nodes CN1, CN2 manage a process or procedure for peer-to-peer discovery and management by routing wireless ad hoc network information therebetween. A first proxy and group communication manager of the first self-organizing distributed service overlay SODSO_1 detects a routing table RT_1 update (denoted ROUTING TABLE UPDATE) on the first communication node CN1 indicating a new peer communication node (the second communication node CN2) is added to the ad hoc network, and initiates a service address and capabilities discovery procedure.

The first proxy and group communication manager retrieves the service and capabilities information on the first communication node CN1 from a first identity and capability registrar and constructs a discover request message. The discover request message includes the IP address of the first communication node CN1, a list of services and associated server application names on the first communication node CN1, and a list of client application names or identities associated with the services on the first communication node CN1. Next, the first proxy and group communication manager sends a discover request message (denoted DISCOVER REQUEST) to the IP address of the new peer communication node (the second communication node CN2) derived from the first routing table RT_1.

Upon receiving the discover request message, the second proxy and group communication manager of the second self-organizing distributed service overlay SODSO_2 of the second communication node CN2 forwards the message to a second peer management service module thereof. The second peer management service module updates the information about the first communication node CN1. A second proxy and group communication manager of the second self-organizing distributed service overlay SODSO_2 of the second communication node CN2 sends a discover acknowledge message (denoted DISCOVER ACKNOWLEDGE) to the first communication node CN1 acknowledging receipt of the discover request message. The discover acknowledge message includes the IP address of the second communication node CN2, a list of services and associated server application names on the second communication node CN2, and a list of client application names or identities associated with the services on the second communication node CN2.

Upon receiving the discover acknowledge message, the first proxy and group communication manager of the first self-organizing distributed service overlay SODSO_1 of the first communication node CN1 forwards the message to a first peer management service module thereof. The first peer management service module updates the information about the second communication node CN2. The first proxy and group communication manager of the first self-organizing distributed service overlay SODSO_1 of the first communication node CN1 sends a discover complete message (denoted DISCOVER COMPLETE) to the second communication node CN2, indicating the discovery process is complete.

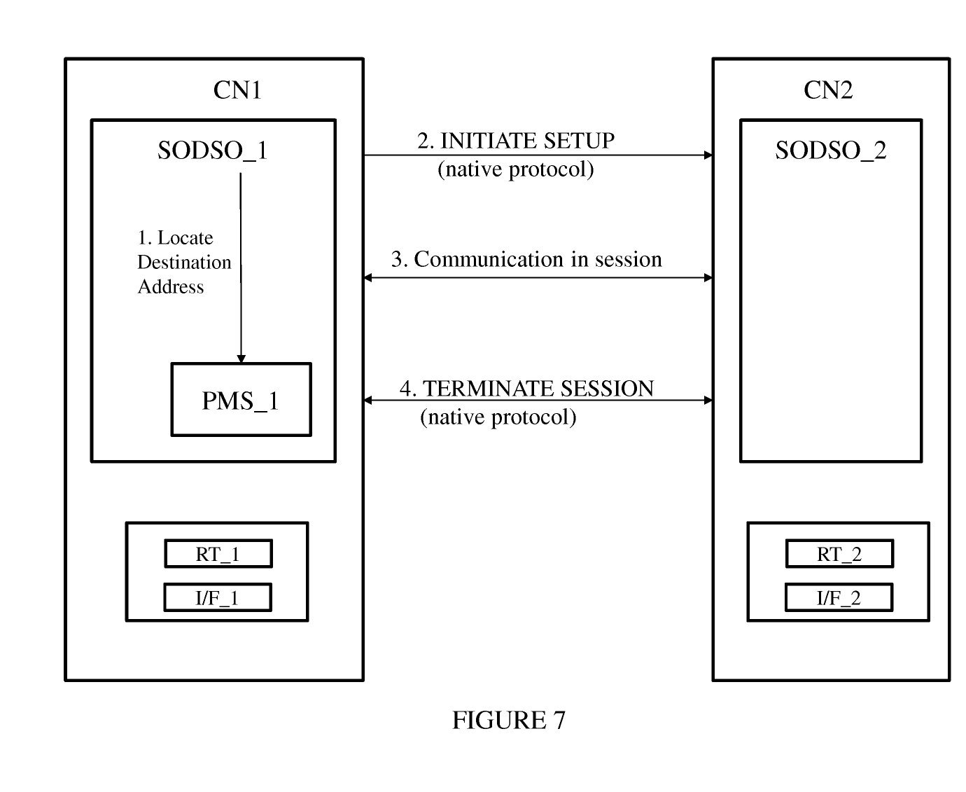

Turning now to FIG. 7, the first and second communication nodes CN1, CN2 initiate and terminate services therebetween. Once the discovery process is complete, the first communication node CN1 is prepared to initiate communication with peer communication nodes (the second communication node CN2) in accordance with the first peer management service module PMS_1 of the first self-organizing distributed service overlay SODSO_1 of the first communication node CN1. Since the server and client applications are co-located using the same IP address on the first communication node CN1, the result of discovery allows communication with both the client and server applications of a peer communication node (a second communication node CN2). Thus, server application-to-server application, client application-to-server application, and client application-to-client application interactions between the first and second communication nodes CN1, CN2 are all possible with a single discovery.

When the first communication node CN1 receives a request from a local client application to initiate communication with a remote client or server application, the first peer management service module PMS_1 is queried (denoted Locate Destination Address) to map the user name or address of the remote client or server application to a destination IP address of the peer communication node (the second communication node CN2).

Once the destination IP is located, the originating server application resident on the first communication node CN1 proceeds to set up communication with the remote peer server application on the second communication node CN2 using a native protocol of the service (denoted INITIATE SETUP). For instance, a SIP-based VoIP call will use the SIP protocol for set up, and an e-mail service will use the simple mail transfer protocol (“SMTP”) for delivery. (See, e.g., “Simple Mail Transfer Protocol,” by J. Klensin, IETF RFC 2821, April 2001). Other exemplary e-mail protocols include an Internet message access protocol (“IMAP”) and a post office protocol (“POP”). Communication between the first and second communication nodes CN1, CN2 then proceeds (denoted Communication in session). The server applications on the first and second communication nodes CN1, CN2 terminate the communication session using the same native protocol for its services (denoted TERMINATE SESSION). This process for communication allows reuse of existing client-server-based applications through co-location and peer-to-peer automated service overlay management. It employs minimal or no modifications to applications and hence incurs negligible additional cost or delay in introducing existing services and applications.

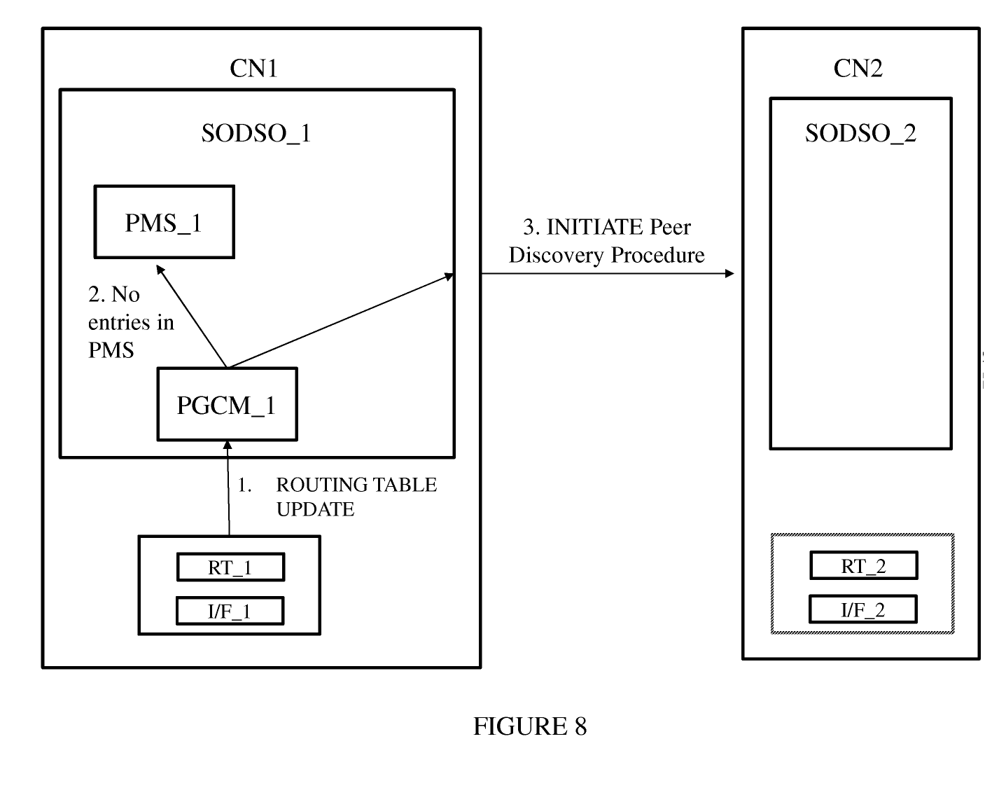

Turning now to FIG. 8, the first and second communication nodes CN1, CN2 participate in a process for merging of networks. When two or more wireless ad hoc networks merge, communication nodes (the first communication node CN1) that managed to establish connectivity update their corresponding routing tables with new destinations (denoted ROUTING TABLE UPDATE). When the first proxy and group communication manager PGCM_1 of the first self-organizing distributed service overlay SODSO_1 of the first communication node CN1 detects an update to the routing table RT_1 therein, the first communication node CN1 queries the first peer management service module PMS_1 to check if there is an entry with the update. If an entry exists, no peer discovery procedure is initiated. If no entry exists (denoted No entries in PMS), a peer discovery procedure is initiated.

The first proxy and group communication manager PGCM_1 then checks if the first self-organizing distributed service overlay SODSO_1 is currently participating in an active discovery procedure with peer communication nodes (the second communication node CN2). If the answer to the aforementioned question is yes, then no peer discovery procedure is initiated. Otherwise, the first proxy and group communication manager PGCM_1 initiates a peer discovery procedure (denoted INITIATE Peer Discovery Procedure) as described above. The process is repeated for all communication nodes with routing table updates in the merged network.

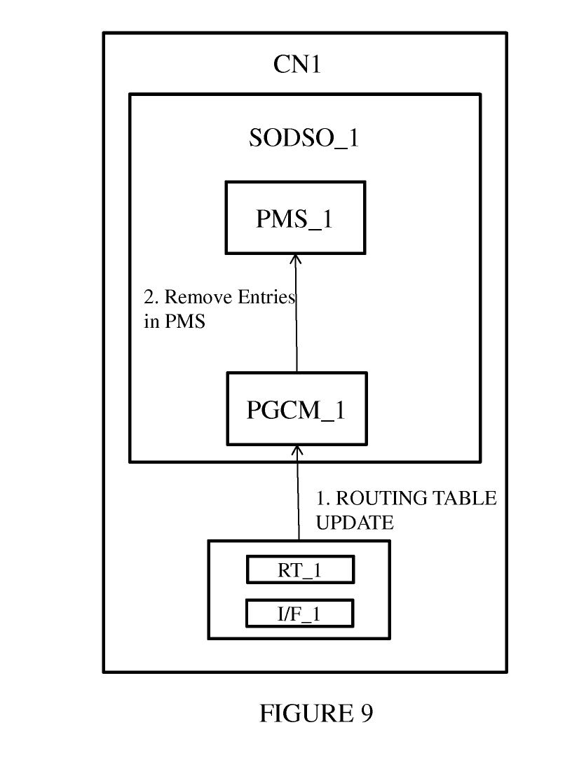

Turning now to FIG. 9, the first communication node CN1 participates in a process for partitioning a wireless ad hoc network. When a wireless ad hoc network is partitioned into two or more networks, a disconnected communication node is removed from a routing table RT_1 of the first communication node CN1. When the first proxy and group communication manager PGCM_1 of the first self-organizing distributed service overlay SODSO_1 detects a disconnected communication node in a routing table RT_1 thereof (denoted ROUTING TABLE UPDATE), the corresponding entry in the first peer management service module PMS_1 is also deleted (denoted Remove Entries in PMS). The process is repeated for all communication nodes that are removed from the routing table.

Thus, a number of differences are apparent between conventional solutions of the communication system as introduced herein. A conventional centralized architecture with a single point of failure is replaced with a distributed architecture as illustrated with respect to FIG. 2. Server applications distributed on the communication nodes are connected through a peer-to-peer self-organizing distributed service overlay, forming a mesh application network that provides highly redundant connections therebetween. Failure of a server application in a group does not impact availability of other communication nodes to continue operating. The outcome is a decentralized self-organizing service network that operates like client server architecture, but without the deficiency of a single point of failure. The wireless ad hoc network solution provides service discovery and peering that is self-organizing as a distributed service overlay. Previous approaches provide a network discovery and peering process that provide peer-to-peer protocols that rely on CHORD or RELOAD (see, e.g., “Chord: A Scalable Peer-to-peer Lookup Service for Internet Applications,” by Ion Stoica, et al., ACM SIGCOMM 2001, pp. 149-160, August 2001, “A SIP Usage for RELOAD,” by C. Jennings, et al., draft-ietf-p2psip-sip-07, Jan. 17, 2012, and “Using Lightweight Modeling to Understand Chord,” by Pamela Zave, Computer Communication Review, Volume 42, Number 2, April 2012, which are incorporated herein by reference), whereas the wireless ad hoc network solution provides ad hoc peer-to-peer routing.

Previous approaches adopt a top-down methodology. A wireless ad hoc network solution formed with a self-organizing distributed service overlay as introduced herein adopts a bottom-up paradigm for creating an ad hoc service overlay. This eliminates the need for a new layer of peer-to-peer protocol since peer-to-peer discovery is inherent in ad hoc routing protocols. The ad hoc application overlay network mirrors the underlying peer-to-peer network topology through the routing information of the communication nodes. No explicit peer-to-peer protocol is needed at service layer employing an ad hoc application overlay network. The result is a simplified and more efficient cross-layer (application and network) binding of routing information with service peers (clients and server applications, and communication nodes).

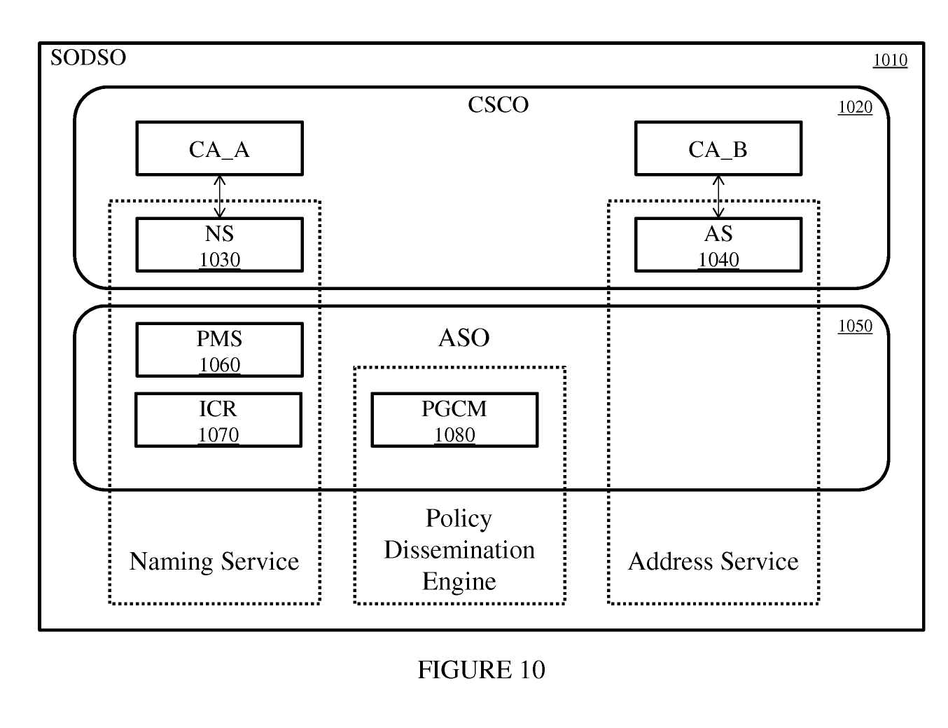

Turning now to FIG. 10, illustrated is a block diagram of an embodiment of a self-organizing distributed service overlay 1010 demonstrating a naming and an address assignment service. The self-organizing distributed service overlay 1010 is fowled with a client-server co-location module 1020 that includes a client application CA_A coupled to a name service (“NS”) module 1030 and a client application CA_B coupled to an address service (“AS”) module 1040. The self-organizing distributed service overlay 1010 is also formed with an autonomous service overlay module 1050 that includes a peer management service module 1060, an identity and capability registrar 1070, and a proxy and group communication manager 1080. Thus, a naming service is constructed with the distributed name service module 1030, the peer management service module 1060 and the identity and capability registrar 1070. A policy dissemination engine is constructed with the proxy and group communication manager 1080, and an address management service is constructed with the address service module 1040. For an understanding of domain names, in general, see “Domain Names—Concepts and Facilities,” P. Mockapetis, IETF RFC 1034, November 1987, and “Domain Names-Implementation and Specification,” P. Mockapetis, IETF RFC 1035, November 1987, which are incorporated herein by reference.

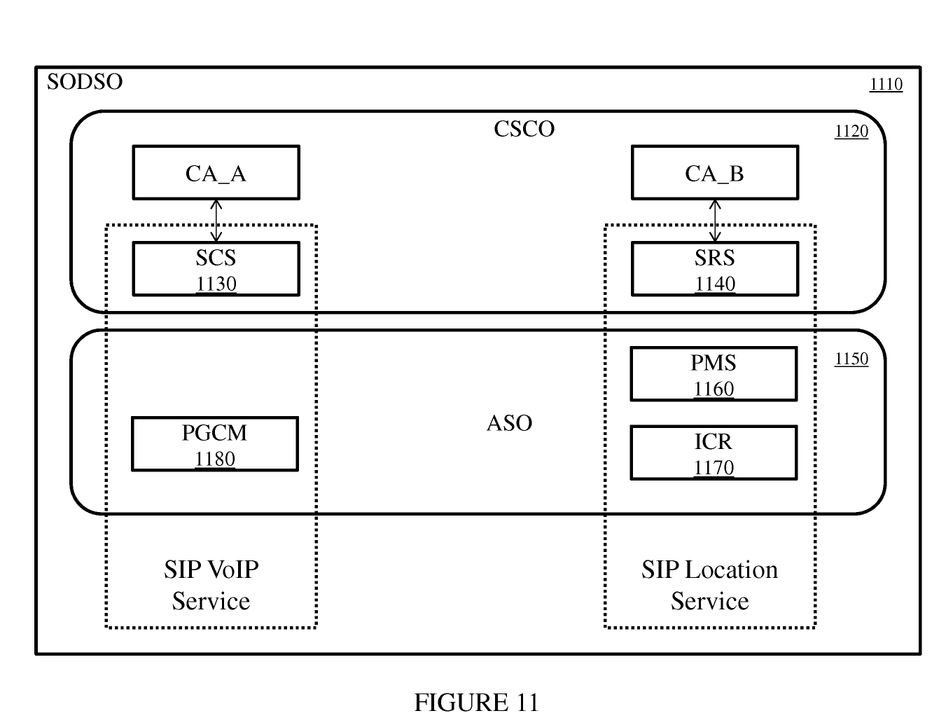

Turning now to FIG. 11, illustrated is a block diagram of an embodiment of a self-organizing distributed service overlay 1110 demonstrating session initiation protocol related services. The self-organizing distributed service overlay 1110 is formed with a client-server co-location module 1120 that includes a client application CA_A coupled to a SIP call service (“SCS”) module 1130 and a client application CA_B coupled to a SIP registrar service (“SRS”) module 1140. The self-organizing distributed service overlay 1110 is also formed with an autonomous service overlay module 1150 that includes a peer management service module 1160, an identity and capability registrar 1170, and a proxy and group communication manager 1180. Thus, a SIP VoIP service for a VoIP client application CA_A is provided by an SIP call service module 1130 and by the proxy and group communication manager 1180. A SIP location service for a location-providing client application CA_B is provided by the SIP registrar service module 1140 and by the peer management service module 1160 and the identity and capability registrar 1170. For a better understanding of session initiation protocol, see, e.g., “SIP-Based Multimedia Services Provision In Ad Hoc Networks,” by Yacine Rebahi, et al., Seventh IFIP International Conference on Mobile and Wireless Communications Networks, Marrakech, Morocco, Sep. 19-21, 2005, which is incorporated herein by reference.

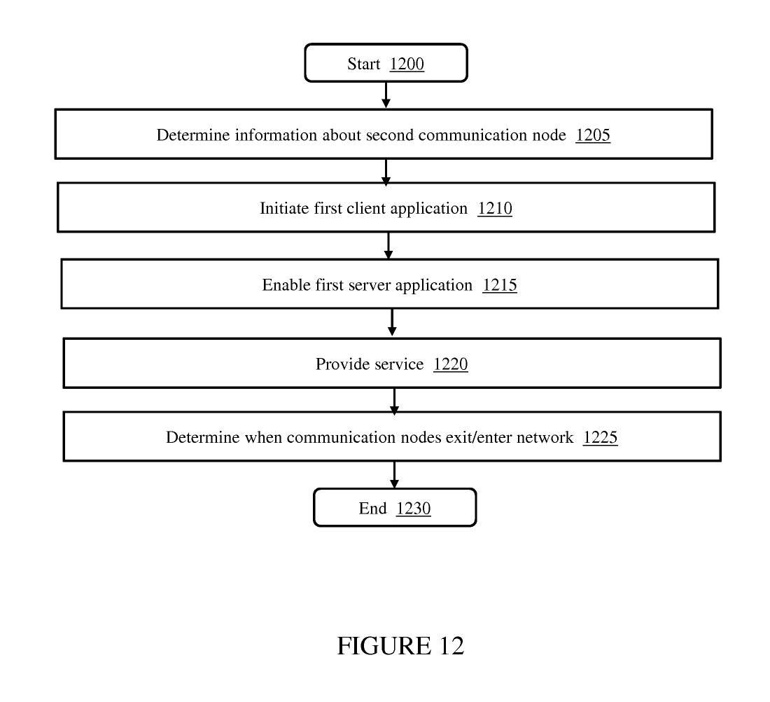

Turning now to FIG. 12, illustrated is a flow diagram of an embodiment of a method of enabling peer-to-peer communication between a plurality of communication nodes in a wireless ad hoc network. A first communication node includes a first server application and an associated first client application and a second communication node includes a second server application and an associated second client application. It should be understood that the first and second communication nodes generally include a plurality of server and client applications. The method begins at a start step or module 1200. At a step or module 1205, the method determines an identity and service capability of the second communication node via, for instance, a peer discovery procedure. The method may employ information in a routing table to determine an identity and service capability of the second communication node. At a step or module 1210, the method initiates the first client application on the first communication node.

At a step or module 1215, the method enables the first server application with the first client application on the first communication node to communicate with the second client application via the second server application on the second communication node. At a step or module 1220, the method provides a service associated with the first client application and second client application between the first server application and the second server application including managing communication resources therebetween. The service may be a web service and the first server application employs a hypertext transfer protocol to communicate with the second server application. The service may be an e-mail service and the first server application employs a simple mail transfer protocol to communicate with the second server application. Additionally, the first and second server applications may employ the Internet message access protocol or the post office protocol to communicate with the first and second client applications, respectively. At a step or module 1225, the method employs information in a routing table to determine when at least one of a plurality of communication nodes exits or enters the wireless ad hoc network. For instance, the method employs information in the routing table to determine a disconnected communication node of a plurality of communication nodes when the wireless ad hoc network is partitioned. The method ends in a step or module 1230.

Thus, as introduced herein, a self-organizing distributed service overlay, and an apparatus and a method of enabling peer-to-peer communication between a plurality of communication nodes in a wireless ad hoc network has been introduced herein. A first communication node (e.g., the user equipment server 110 of FIG. 1) includes a first server application and an associated first client application and a second communication node (e.g., the another user equipment server 170 of FIG. 1) includes a second server application and an associated second client application. In an environment of the first communication node, an apparatus including a processor in accordance with a memory is configured to determine an identity and service capability of a second communication node via, for instance, a peer discovery procedure. The apparatus may employ information in a routing table to determine an identity and service capability of the second communication node. The processor in accordance with the memory is also configured to initiate the first client application on the first communication node.

The processor in accordance with the memory is also configured to enable the first server application with the first client application on the first communication node to communicate with the second client application via the second server application on the second communication node. The processor in accordance with the memory is also configured to provide a service associated with the first client application and second client application between the first server application and the second server application including managing communication resources therebetween. The service may be a web service and the first server application employs a hypertext transfer protocol to communicate with the second server application. The service may be an e-mail service and the first server application employs a simple mail transfer protocol to communicate with the second server application. The processor in accordance with the memory is also configured to employ information in a routing table to determine when at least one of the plurality of communication nodes (e.g., the second communication node) exits or enters the wireless ad hoc network. For instance, the apparatus may employ information in the routing table to determine a disconnected communication node of the plurality of communication nodes (e.g., the second communication node) when the wireless ad hoc network is partitioned.

Program or code segments making up the various embodiments may be stored in a computer readable medium or transmitted by a computer data signal embodied in a carrier wave, or a signal modulated by a carrier, over a transmission medium. For instance, a computer program product including a program code stored in a computer readable medium (e.g., a non-transitory computer readable medium) may form various embodiments. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, an optical disk, a hard disk, a fiber optic medium, a radio frequency (“RF”) link, and the like. The computer data signal may include any signal that can propagate over a transmission medium such as electronic communication network communication channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same may be reordered, omitted, added, etc., and still fall within the broad scope of the various embodiments.

Moreover, the scope of the various embodiments is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized as well. Accordingly, the appended claims are intended to include within their scope such processes, machines, manufacture, compositions of matter, means, methods, or steps.

1-20. (canceled)

21. A method for enabling peer-to-peer communication between a plurality of communication nodes in a wireless ad hoc network utilizing a self-organizing distributed service overlay (SODSO), the method comprising the steps of:
providing cross-layer binding by connecting each communication node to each of the other communication nodes in the wireless ad hoc network at both an IP network layer (L3) and a link layer (L2);
implementing a server application and a paired client application in each of the plurality of communication nodes, wherein a client-server co-location (CSCO) function in each communication node provides the client application to the communication node in which the server application is implemented and to any connected communication node through co-hosting on the same communication node; and
enabling each communication node to discover and manage application peers as communication nodes join or leave the wireless ad hoc network.

22. The method as recited in claim 1, wherein the step of enabling each communication node to discover and manage application peers is performed by an autonomous service overlay (ASO) function implemented in each of the plurality of communication nodes, wherein the ASO function maintains for discovery by other communication nodes, an IP address of the communication node in which the ASO function is implemented and a list of server application names and associated client application names implemented in the communication node in which the ASO function is implemented.

23. The method as recited in claim 2, wherein the ASO function also maintains IP addresses of connected communication nodes and a list of services and associated server application names on the connected communication nodes.

24. The method as recited in claim 3, wherein the ASO function includes a proxy and group communication manager (PGCM) that performs the steps of:
monitoring updates in a routing table;
managing communication with the connected communication nodes; and
coordinating internal and external communication through the SODSO on behalf of the communication node in which the ASO function is implemented.

25. The method as recited in claim 4, further comprising employing information in the routing table to determine the identities and service capabilities of other communication nodes in the wireless ad hoc network.

26. The method as recited in claim 4, further comprising employing information in the routing table to determine when at least one of the plurality of communication nodes joins or leaves the wireless ad hoc network.

27. The method as recited in claim 4, further comprising employing information in the routing table to determine a disconnected communication node of the plurality of communication nodes when the wireless ad hoc network is partitioned.

28. A self-organizing distributed service overlay (SODSO) for enabling peer-to-peer communication between a plurality of communication nodes in a wireless ad hoc network, the SODSO comprising:
a cross-layer binding formed by connecting each communication node to each of the other communication nodes in the wireless ad hoc network at both an IP network layer (L3) and a link layer (L2);
a server application and a paired client application stored in a non-transitory memory and executed by a processor in each of the plurality of communication nodes, wherein a client-server co-location (CSCO) function in each communication node provides the client application to the communication node in which the server application is implemented and to any connected communication node through co-hosting on the same communication node; and
an autonomous service overlay (ASO) function implemented in each of the plurality of communication nodes, wherein the ASO function enables each communication node to discover and manage application peers as communication nodes join or leave the wireless ad hoc network.

29. The SODSO as recited in claim 8, wherein the ASO function maintains for discovery by other communication nodes, an IP address of the communication node in which the ASO function is implemented and a list of server application names and associated client application names implemented in the communication node in which the ASO function is implemented.

30. The SODSO as recited in claim 9, wherein the ASO function also maintains IP addresses of connected communication nodes and a list of services and associated server application names on the connected communication nodes.

31. The SODSO as recited in claim 10, further comprising a routing table implemented in each of the plurality of communication nodes, wherein the ASO function includes a proxy and group communication manager (PGCM) that monitors updates in the routing table, manages communication with the connected communication nodes, and coordinates internal and external communication through the SODSO on behalf of the communication node in which the ASO function is implemented.

32. The SODSO as recited in claim 11, wherein the PGCM employs information in the routing table to determine the identities and service capabilities of other communication nodes in the wireless ad hoc network.

33. The SODSO as recited in claim 11, wherein the PGCM employs information in the routing table to determine when at least one of the plurality of communication nodes joins or leaves the wireless ad hoc network.

34. The SODSO as recited in claim 11, wherein the PGCM employs information in the routing table to determine a disconnected communication node of the plurality of communication nodes when the wireless ad hoc network is partitioned.

35. A computer program product comprising program code stored in a non-transitory computer readable medium operable to enable peer-to-peer communication between a plurality of communication nodes in a wireless ad hoc network utilizing a self-organizing distributed service overlay (SODSO), wherein when the program code is executed by a processor in each of the communication node, the processors are caused to:
provide cross-layer binding by connecting each communication node to each of the other communication nodes in the wireless ad hoc network at both an IP network layer (L3) and a link layer (L2);
execute a server application and a paired client application in each of the plurality of communication nodes, wherein a client-server co-location (CSCO) function in each communication node provides the client application to the communication node in which the server application is implemented and to any connected communication node through co-hosting on the same communication node; and
enable each communication node to discover and manage application peers as communication nodes join or leave the wireless ad hoc network.

36. The computer program product as recited in claim 15, wherein the processors enable each communication node to discover and manage application peers utilizing an autonomous service overlay (ASO) function implemented in each of the plurality of communication nodes, wherein the ASO function maintains for discovery by other communication nodes, an IP address of the communication node in which the ASO function is implemented and a list of server application names and associated client application names implemented in the communication node in which the ASO function is implemented.

37. The computer program product as recited in claim 16, wherein the ASO function also maintains IP addresses of connected communication nodes and a list of services and associated server application names on the connected communication nodes.

38. The computer program product as recited in claim 17, wherein the ASO function includes a proxy and group communication manager (PGCM) configured to:
monitor updates in a routing table;
manage communication with the connected communication nodes; and
coordinate internal and external communication through the SODSO on behalf of the communication node in which the ASO function is implemented.

39. The computer program product as recited in claim 18, wherein the ASO function employs information in the routing table to determine the identities and service capabilities of other communication nodes in the wireless ad hoc network.

40. The computer program product as recited in claim 18, wherein the ASO function employs information in the routing table to determine when at least one of the plurality of communication nodes joins or leaves the wireless ad hoc network, and to determine a disconnected communication node of the plurality of communication nodes when the wireless ad hoc network is partitioned.
